(19) United States
(12) Patent Application Publication
(10) Pub. No.: US 2026/0154782 A1
(43) Pub. Date: Jun. 4, 2026

(54) AI-BASED AND LIDAR-BASED IMAGE PROCESSING PIPELINE FOR IMMERSIVE EDITING AND COLLABORATIVE DESIGN

(71) Applicant: Hamad Bin Khalifa University (HBKU), Doha (QA)

(72) Inventors: Muhammad Muhammad Tukur, Doha (QA); Marco Agus, Doha (QA); Uzair Shah, Doha (QA); Jens Schneider, Doha (QA); Sara Jashari, Doha (QA); Mahmood Al-Zubaidi, Doha (QA); Noora Fetais, Doha (QA); Yehia Boraey, Doha (QA); Alberto Jaspe Villanueva, Doha (QA)

(21) Appl. No.: 19/393,065

(22) Filed: Nov. 18, 2025

Related U.S. Application Data
(60) Provisional application No. 63/726,943, filed on Dec. 2, 2024.

(51) Int. Cl. G06T 3/4053; G06V 10/82; G06V 20/70; H04N 13/122

(52) U.S. Cl. CPC G06T 3/4053; G06V 10/82; G06V 20/70; H04N 13/122

(57) ABSTRACT

The present disclosure provides for an AI-based and LIDAR-based image processing pipeline for immersive editing and collaborative design. According to one aspect of the present disclosure an AI-based and LIDAR-based image processing pipeline for immersive editing and collaborative design. According to a second aspect of the present disclosure a method of using an AI-based and LIDAR-based image processing pipeline for immersive editing and collaborative design.

### PRIORITY CLAIM AND CROSS-REFERENCE TO RELATED APPLICATIONS

This application claims priority to and the benefit of U.S. Provisional Patent App. No. 63/726,943 filed Dec. 2, 2024, titled AI-BASED AND LIDAR-BASED IMAGE PROCESSING PIPELINE FOR IMMERSIVE EDITING AND COLLABORATIVE DESIGN, the contents of which are incorporated by reference herein in their entirety and relied upon.

### BACKGROUND

The metaverse represents a convergence of virtually enhanced physical and digital realities, creating a collective virtual shared space. This expansive digital universe allows users to interact, socialize, and engage in various activities through avatars and digital representations. Applications of the metaverse span from gaming and social networking, to education and virtual commerce necessitating advanced technologies for creating and interacting with immersive environments.

A key application of these technologies is virtual staging, where the objective is to create and interact with realistic alternative designs of real indoor environments. Virtual staging is particularly valuable in real estate, interior design, furniture retail, construction, and building maintenance, as it enables the visualization of captured furnished spaces without physical furniture and allows seamless replacement with virtual alternatives. Achieving this requires an end-to-end workflow—from capturing the 3D environment, to processing it and extracting the necessary data for editing, to implementing the design changes, and finally delivering an immersive virtual presentation.

There are two distinct pipelines for the production and exploration of immersive environments: an AI-based image processing pipeline for exploratory purposes, and a LIDAR-based pipeline focusing on immersive editing and collaborative design.

AI-Based Image Processing Pipeline: This pipeline leverages advanced AI algorithms that are integrated and synergized to process and enhance panoramic images of indoor environments for virtual staging applications in the metaverse (see FIG. 1). Key integrated technologies include a system for clutter removal, multitask dense prediction, semantic photorealistic style transfer, super-resolution, a rendering system, and a system for the automatic generation of stereoscopic environments for metaverse applications.

LIDAR-Based Pipeline: This pipeline focuses on capturing measurable 3D models of indoor spaces using LIDAR technology. The captured data is then used for immersive editing and collaborative design. This approach allows users to interact with and modify virtual environments in real-time, providing a high level of detail and accuracy. For example, the use of LIDAR scanning in collaborative platform applications like Spatial.io enables detailed virtual walkthroughs and object placement, enhancing the realism of virtual staging.

A qualitative comparison of these two technologies demonstrates their respective strengths and limitations in enabling immersive editing and collaborative design. For instance, while LIDAR provides high accuracy and detailed spatial data, AI-based methods offer flexibility and efficiency in image processing, making them suitable for rapid staging and exploratory tasks. The practical implications of these technologies in various industries highlights their potential to transform fields such as real estate, furniture retail, interior design, construction, remote collaboration, and immersive training.

In turn, there is a need for an AI-based and LIDAR-based image processing pipeline for immersive editing and collaborative design.

### SUMMARY

The present disclosure provides for an AI-based and LIDAR-based image processing pipeline for immersive editing and collaborative design.

According to one non-limiting aspect of the present disclosure, an exemplary embodiment of an AI-based and LIDAR-based image processing pipeline for immersive editing and collaborative design.

According to a second non-limiting aspect of the present disclosure, an exemplary embodiment of a method of using an AI-based and LIDAR-based image processing pipeline for immersive editing and collaborative design.

Additional features and advantages are described in, and will be apparent from, the following Detailed Description and the Figures. The features and advantages described herein are not all-inclusive and, in particular, many additional features and advantages will be apparent to one of ordinary skill in the art in view of the figures and description. In addition, any particular embodiment does not have to have all of the advantages listed herein and it is expressly contemplated to claim individual advantageous embodiments separately. Moreover, it should be noted that the language used in the specification has been selected principally for readability and instructional purposes, and not to limit the scope of the inventive subject matter.

The two presented pipelines—AI—based and LiDAR-based image processing for immersive editing and collaborative design—can be combined to leverage their complementary strengths. For instance, LiDAR-based models offer high spatial accuracy but are limited by occlusions and their inherent 2.5D nature. The AI-based pipeline, as discussed in this application, can enhance these LiDAR-generated environments by filling occluded regions, applying semantic edits, and enabling more realistic and interactive virtual staging.

### BRIEF DESCRIPTION OF THE DRAWINGS

FIGS. 1A-D show an AI-based image processing pipeline for immersive editing and collaborative design, according to an example embodiment of the present disclosure.

FIGS. 2A-D show a demonstration of an AI-based image processing pipeline for immersive editing and collaborative design, according to an example embodiment of the present disclosure.

FIG. 3 shows a sample of a polycam LiDAR scan, according to an example embodiment of the present disclosure.

FIG. 4 shows a sample of a polycam classroom creation, according to an example embodiment of the present disclosure.

### DETAILED DESCRIPTION

The present disclosure generally relates to an AI-based and LIDAR-based image processing pipeline for immersive editing and collaborative design.

The disclosed technology deals with technologies for immersive editing of 3D indoor environments and with methods for automatic processing of panoramic images. Immersive editing for virtual staging: In general, the application of immersive technologies and digital twins in the construction industry is still in the early stages. For what concerns interior design, immersive frameworks focusing on material selection, or lighting design have been proposed, but the usage of immersive technologies gained most of popularity during the pandemic for the generation of virtual tours experiences, especially for real estate applications, and interior design, through the usage of 3D scanning technologies or specialized cameras. Very recently, methods exploiting deep learning technologies has been considered for the automatic generation of 3D indoor scenes, through graph convolutional networks, or text based generative models, but these methods are still far from real-world application.

AI-based technologies for indoor panoramic images: Omnidirectional cameras are very popular for the fast and accurate acquisition of indoor scenes since they can capture most of the 3D content with few shots. In the last decade, various data-driven technologies have been developed to support the automatic creation of digital content from panoramic images. Examples include: extraction of room layouts, geometry estimation, signal extraction for inverse rendering, clutter removal, style transfer, and novel pose synthesis for virtual exploration. Those methods have been applied to pipelines for inverse rendering, and for virtual staging of indoor scenes. This technology illustrates the integration of various AI panoramic image processing components to automatically generate immersive exploration experiences of refurnished indoor environments.

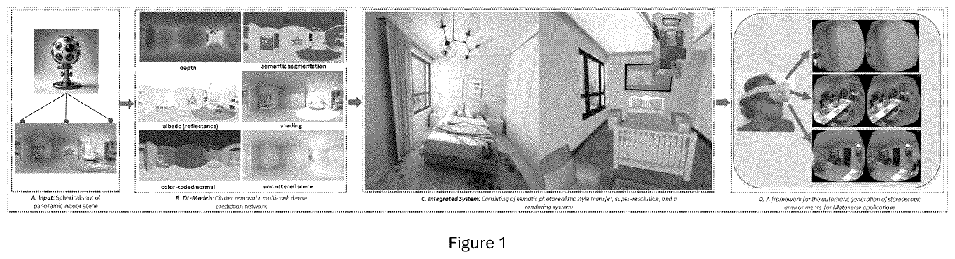

The disclosed technology is an end-to-end AI-image-based pipeline based on semiautomatic processing and editing of single panoramic images for performing image-based virtual staging tasks and deploying the generated environments in Metaverse-ready web resources for immersive exploration. The framework is depicted in FIG. 1 and integrates various components for automatic processing, generation, and stereoscopic exploration of immersive indoor environments. FIG. 1 shows several AI models integrated and synergized to process and generate the virtual staging environment. The framework is composed of four integral modules: (A) Input Module: A single RGB panoramic image of an indoor environment taken using a 360° camera; (B) Deep learning Models: This component comprises a network designed for the extraction of various signals, the present technology autonomously procures essential signals such as depth, semantics, shading, reflectance, color-coded normals, and empty scene representation, thereby synergizing the generation of virtual staging applications for the metaverse; (C) Example of virtual staging process leveraging the AI-Based Image Processing Pipeline: the disclosed technology includes a Semantic, Geometry-Aware and Shading Independent Photorealistic Style Transfer for Indoor Panoramic Scenes Framework based on Generative Deep Models, such as Generative Adversarial Network, Stable Diffusion, etc., used for semantic style transfer, a super-resolution (SR) model based on a Hybrid Attention Mechanism that combines channel attention, window-attention, and overlapping cross-attention to activate more input pixels for SR is used to increase details, a rendering system is used for interactive exploration, object insertion, and editing; (D) The disclosed technology for the automatic generation and exploration of immersive scenes representing indoor stereoscopic environments, which can be navigated using VR setups on lightweight WebXR viewers, making it ideal for Metaverse applications.

Starting from single panoramic images (left), the disclosed technology removes clutter, estimates the necessary signals for both cluttered and decluttered scenes, and applies semantic style transfer to enhance visual aesthetics. The pipeline further increases detail by employing a super-resolution model, enabling high-fidelity editing. The result is the presentation of immersive, high-resolution spherical indoor scenes that can be explored using VR setups on lightweight WebXR viewers (c.f. FIG. 1(C-D)), making them ready for Metaverse applications (right).

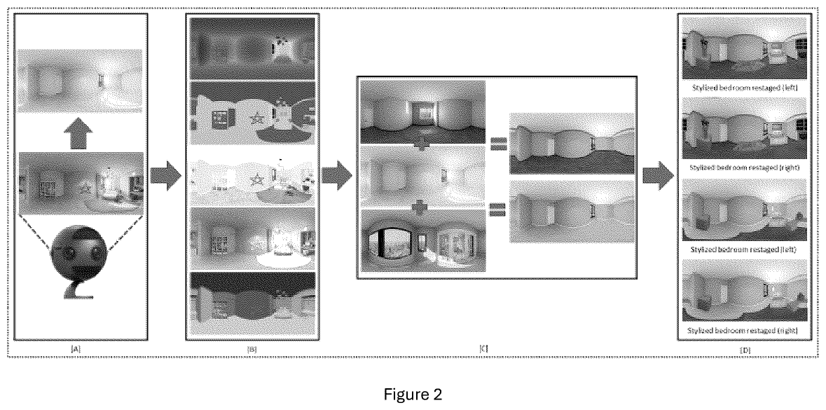

FIGS. 2A-D show a demonstration of an AI-based image processing pipeline for immersive editing and collaborative design: (A) Input: a spherical shot of a panoramic indoor scene (bottom) and an example of instant automatic emptying of the scene (top); (B) Example of multiple inferences obtained with a multitask dense prediction model on a single synthetic RGB image from Structured 3D, from top to bottom, the depth prediction, semantic inference, reflectance, shading, and color-coded normals; (C) Semantic photorealistic style transfer examples generated using the disclosed technology (from 2 different style images), a super resolution model is also applied to enhance details; (D) A rendering system allows users to compose a new scene by placing virtual objects, a framework for the automatic generation of stereoscopic environments enables users to view the scene from different angles, creating an impression of depth and solidity.

Instant clutter removal: For this task, the disclosed technology uses a model based on inpainting for Instant Automatic Emptying of Panoramic Indoor Scenes, which is a deep learning architecture to automatically remove clutter from panoramic indoor images, providing both a photorealistic view and depth estimation of the empty scene. This end-to-end solution leverages a lightweight deep learning network to process 360 degree panoramic images, distinguishing between permanent architectural features and removable clutter. The method begins by generating an attention mask to identify cluttered regions based on geometric differences between cluttered and uncluttered scenes. This mask guides the subsequent image and depth generation, using gated convolutions and high-order geometric constraints during training to ensure the output is both visually and geometrically plausible (FIG. 2A). The approach is unique in its holistic treatment of the entire scene, as opposed to traditional methods that focus on single object removal. It shifts the computational burden to the training phase, allowing for interactive-speed performance during interference.

Multitask dense prediction: Signals such as semantic segmentation, depth, color-coded normals, and intrinsic decomposition signal distinguishing reflectance (albedo) and shading are crucial for generating immersive and interactive environments for virtual staging applications in the metaverse. To this end, the disclosed technology includes a deep-learning framework designed to infer multiple pixel-wise signals from a single panoramic image. The framework is able to concurrently extract diverse types of information—such as depth, normals, semantic segmentation, reflectance, and shading—from indoor panoramic images (See FIG. 2B). This is achieved through a transformer-based encoder-decoder architecture that leverages multiple heads for dense estimation. By incorporating a context adjustment layer, the framework ensures effective knowledge distillation between the encoder and various decoder heads, enhancing the quality of predictions for each signal.

Indoor style transfer: Style transfer is used for changing the appearance of indoor environments to look like target scenes. It enhances user engagement, making it a valuable tool for virtual staging. The methodology integrates several components into a generative deep model framework. Firstly, it employs a shading decomposition scheme to separate reflectance (albedo) from shading, thus preventing shading-related artifacts during the style transfer process. This ensures that the style transfer affects only the intrinsic colors of surfaces, not their illumination. Secondly, the architecture incorporates strong geometry constraints through the use of layout and depth inference during training, enforcing shape consistency between the generated and ground truth scenes. This is achieved by introducing custom geometry-aware losses that account for the 3D characteristics of indoor scenes, including clutter, layout, and edges. Additionally, the method applies a hybrid-transformer-based super-resolution technique to enhance the detail and resolution of the generated images, making them suitable for immersive applications. The visual results (FIG. 2C-D) confirm the effectiveness of the method in producing realistic and visually pleasing indoor scenes.

Extending resolution of indoor spherical representations: In general, current CNN architectures used for generating signals from spherical images are limited to a maximum resolution of 1024×512. This is significantly lower than the native resolutions of RGB panoramas, which can exceed 4096×2048 in modern commodity 360° cameras. Consequently, this limitation poses a major challenge for VR applications. For example, a 90°×90° view generated from a 1024×512 panorama would yield a resolution of only 256×256. Super-resolution is a common technique employed to overcome this limitation by reconstructing high-resolution images from single or multiple low-resolution inputs. State-of-the-art solutions leverage data distribution learning through Generative Adversarial Networks (GANs) with spectral normalization or hybrid attention technique integrated with image transformers to enhance reconstruction quality. However, these methods often require substantial computational time, making them less suitable for real-time VR applications. The present technology addresses this challenge by generating super-resolution outputs for both RGB and depth signals using a super-resolution model based on the Hybrid Attention Mechanism, which achieves an optimal balance between accuracy and processing efficiency—making it more practical for VR-related use cases.

Editing system: Editing systems could significantly advance the capabilities of virtual staging by providing a robust, scalable, and interactive solution for transforming panoramic images into high-resolution 3D environments. Their contributions are vital for the development and deployment of immersive experiences in the metaverse, making it an indispensable tool for various XR applications. The present technology uses OpenGL-based software for processing, editing and presenting immersive high-resolution spherical indoor scenes, which is a comprehensive system for transforming single 360° panoramic images into interactive, high-resolution 3D representations suitable for various Extended Reality (XR) applications. The framework integrates a series of advanced deep-learning models to process, edit, and render spherical images of indoor environments. The core components of the system include a novel architecture for geometric and semantic information extraction, a super-resolution module for enhancing image resolution, and an interactive editor for scene manipulation and exploration.

The methodology begins with the acquisition of a single panoramic image, which is processed to infer depth and semantic segmentation using gated and dilated convolutions. These inferred signals are then fed into a super-resolution module based on image transformers, significantly improving the resolution of both color and depth signals. The enhanced high-resolution data allows for the creation of detailed 3D models that can be explored and edited interactively. Users can perform various operations, such as virtual object insertion, scene refurnishing, and deferred shading, on the reconstructed indoor scene (FIGS. 1C & 2D). The system supports rendering in multiple modalities, including point cloud, polygonal, and wireframe representations, making it versatile for different applications.

Automatic stereo generation: The present technology uses a method for deep synthesis and exploration of omnidirectional stereoscopic environments from a single surround-view to automatically generate stereoscopic environments for metaverse applications. This method's capabilities for view synthesis from single panoramic images provides a robust foundation for creating immersive, interactive, and visually compelling environments, essential for advancing virtual staging in the metaverse and enhancing user experiences across various industries. The technique introduces a framework to create and explore immersive stereoscopic scenes using single panoramic images. The core methodology is a data-driven architecture designed for panoramic monocular depth estimation and view synthesis. The framework starts by inferring a fixed set of panoramic stereo pairs from a single panoramic image, which are then seamlessly fused to cover the entire viewing workspace when explored through VR headsets (See FIG. 1D). This architecture utilizes a lightweight gated network for depth estimation and view synthesis, ensuring scalability and low latency. The depth map is estimated from the input panoramic image and used to generate new views by reprojecting and inpainting the scene. This approach maintains high visual detail and stereo consistency, achieved through a combination of photometric loss and hybrid-attention-based super-resolution techniques. The result is a set of precomputed omnidirectional stereo pairs that provide a seamless and photorealistic stereoscopic experience. The system is integrated into WebXR viewers, making it accessible on various VR headsets and demonstrating effective performance across different indoor scenes.

LiDAR technology has emerged as a powerful tool in the construction of building-scale 3D acquisition. While this technology has existed for a long time and is well-established for indoor reconstruction, its recent integration in commodity multi-purpose devices is expanding its range of applications. In particular, its inclusion as a standard feature in Apple's flagship smartphones over the past four years highlights its increasing significance for non-professional users. These phone-based LiDAR scanners excel in generating detailed oriented point cloud data of real-world environments with good precision. Coupled with surface reconstruction techniques (e.g., the well-established Screened Poisson Surface Reconstruction), they can create complete 3D models that can be further enhanced with additional 3D objects, creating immersive and interactive experiences. Collaborative platforms like Spatial.io could leverage these LiDAR scanned spaces to facilitate meaningful user interactions, a core aspect of the metaverse. Within Collaborative Platforms such as Spatial.io, users can engage in activities such as virtual staging, where they populate scanned rooms with furniture and other objects, fostering a dynamic and collaborative virtual environment. Additionally, users can voice chat and interact across multiple platforms, including VR, web, and mobile, without the need to manually configure the user experience for different platforms.

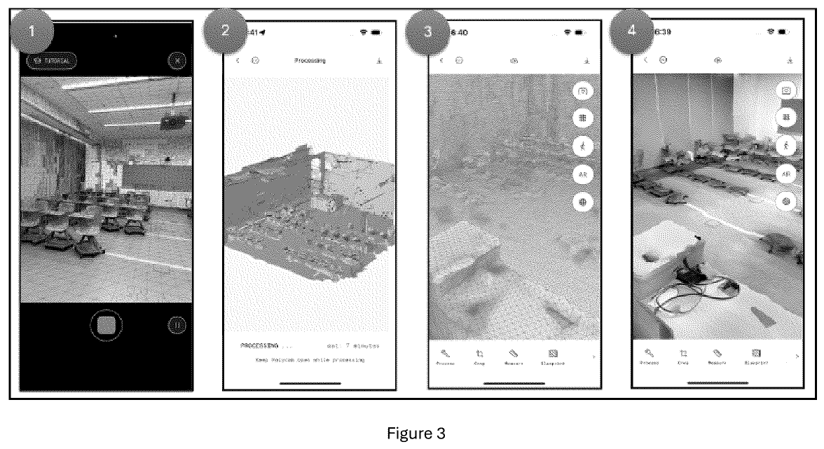

LiDAR scanning: LiDAR scanning on mobile devices has become increasingly feasible due to the integration of depth sensors in modern smartphones, such as those from Apple. These sensors enable real-time 3D data acquisition by combining LiDAR depth measurements with camera imagery and inertial sensor data (e.g., gyroscopes). Various mobile applications have been developed to support different objectives—ranging from dense point cloud generation to rapid low-poly model reconstruction. Some approaches perform processing locally on the device for speed and accessibility, while others offload reconstruction tasks to cloud-based servers for higher fidelity. Typically, a room-sized indoor environment (e.g., 80-100 square meters) can be scanned and processed into a 3D mesh within 10-15 minutes, depending on the system's optimization and scanning method used. (See FIG. 3).

FIG. 3 demonstrates the process and outcomes of using Polycam's LiDAR mode to scan a typical classroom. The images show the initial scanning phase and the resulting detailed 3D model. The process highlights the efficiency and precision of mobile LiDAR scanning for generating accurate and interactive 3D models of real-world environments, which can then be utilized within the metaverse for various applications, including virtual staging and collaborative design.

Collaborative Platform Toolkit: The collaborative platforms such as Spatial Creator Toolkit, a free plugin for the widely used in game engine such as Unity, facilitates the development of interactive, multiplayer experiences. By streamlining the creation process for social spaces, games, and collaborative environments within the metaverse, the toolkit offers a suite of built-in features. These include matchmaking functionalities, synchronized object and variable management, integrated voice and text chat options, and sandbox testing environments. By lowering the barrier to entry for metaverse development, it empowers a broader range of developers to contribute to the evolving metaverse landscape. Notably, creators using the toolkit do not have to manually address networking and user interaction across multiple platforms, including VR, web, and mobile. However, the platform does not fully support many of Unity's components, which limits the creation of advanced experiences. Despite this limitation, the tool effectively provides a simple way to share experiences across various platforms within the metaverse. For more advanced applications game engines could be utilized for building a custom implementation of the features provided in collaborative platforms such as Spatial.io.

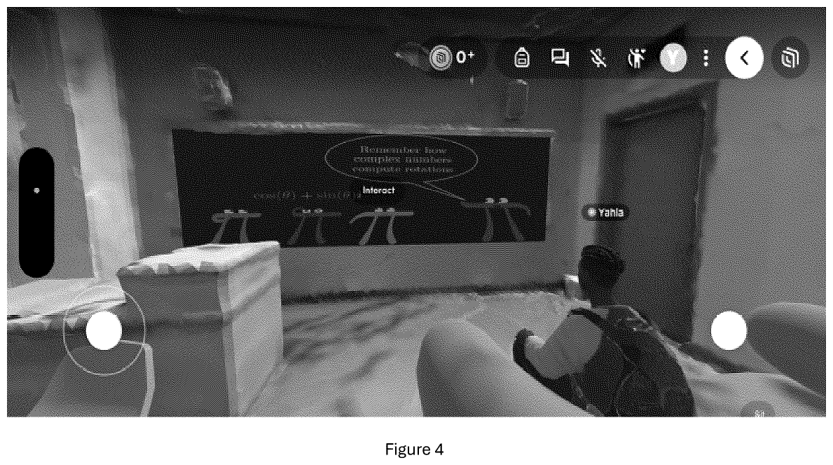

Metaverse exploration: A game engine such as Unity can be leveraged to reimagine a room scanned with LiDAR by importing the low poly 3D models generated from PolyCam into the Unity game engine. Once imported, it is possible to populate the virtual room with furniture and other objects to create an interactive and realistic environment. Through integration with collaborative platforms such as Spatial.io, users can interact within the populated room, utilizing features such as voice and text chat to communicate and provide real-time feedback. This collaborative approach allows users to experience and modify the virtual environment, enhancing the design process and ensuring that the final result meets their needs and expectations. Moreover, it is possible to enable object placement through edge devices on multiple platforms, such as VR and mobile. This capability requires a set database of 3D objects and custom components that facilitate object placements. By combining a game engine such as Unity's powerful rendering capabilities with collaborative platform such as Spatial.io's interactive features, and leveraging edge devices for seamless object manipulation, developers can create immersive and engaging virtual spaces within the metaverse. This facilitates meaningful user interactions and feedback, advancing the possibilities for virtual staging and collaboration in the evolving metaverse landscape (See FIG. 4). FIG. 4 shows a demo showcasing a classroom environment created with Polycam, an iOS application that utilizes iPhone LiDAR sensors, allows users to interact with the environment, communicate via text or audio, or watch an educational video through collaborative platforms such as Spatial.io services.

A qualitative analysis of the various features of the presented pipelines for the generation of immersive indoor environments is shown in Table I. Table I contains the main insights of this analysis. Based on the comparison, the AI-image-based pipeline is better suited for virtual staging applications. Virtual staging does not require users to navigate the entire scene to view the redecorated room, nor does it necessitate a detailed collision mesh for complex physics interactions. While these attributes are valuable advantages of the LiDAR-based pipeline and may justify its use in other contexts, virtual staging prioritizes photo-realism and clutter removal, which the AI image-based pipeline demonstrably excels at. In contrast, the LiDAR pipeline, although capable of automatic generation on edge devices, produces low-poly and unrealistic 3D models. Additionally, the LiDAR system not only lacks automatic clutter removal but also requires significant technical expertise to generate high-quality 3D models from point-cloud data. These limitations further hinder its effectiveness for virtual staging applications. Therefore, the AI-image based pipeline's emphasis on automatic clutter removal, photorealistic stereoscopic experience, and accessibility makes it a more convenient and effective solution for virtual staging applications.

TABLE I
Qualitative comparison of ai-image-based and lidar-based pipelines.

| Feature | AI-Image-Based Pipeline | LiDAR-Based Pipeline |
|---|---|---|
| Data | Single panoramic image of the | LiDAR scan using a mobile device or |
| Acquisition | environment | professional scanner |
| Processing | Deep learning models for clutter | Algorithms like screened poisson surface |
| | removal, signal generation, style | reconstruction to create 3D models from |
| | transfer, and super-resolution | point cloud data |
| Output | A photo-realistic 360 image with | Point cloud data reflecting real-world |
| | semantic segmentation, depth | spatial relationships; intensive data |
| | information, and stylistic | processing and manual configuration |
| | customization, ready for immersive | required for high-quality complex |
| | stereoscopic virtual staging | models. |
| | | Automatic generation yields low-poly 3D |
| | | models, ready for virtual. staging |
| Advantages | Faster processing | High fidelity of |
| | Unique and stylized environments | real-world spatial details |
| | Well-suited for indoor spaces | Full physics integration for realistic |
| | | simulations |
| | | Full scene exploration |
| Limitations | Quality dependent on input image | Requires specialized equipment. |
| | Limited field of view | Less detailed for large or outdoor |
| | | spaces. |
| | | Struggles with complex or cluttered |
| | | environments. |
| | | Does not support clutter removal. |
| | | Struggles with transparent and |
| | | reflective surfaces. |
| Realism | High (photo-realistic) | Low (automatic low-poly model |
| | | generation) |
| Physics | Limited (using depth maps) | Full (using collision mesh derived from |
| | | the 3D mesh) |

The integration of advanced AI and LIDAR-based technologies for virtual staging has transformative potential across several industries.

As described below, these technologies can be effectively applied in real estate, furniture retail, interior design, the construction industry, remote collaboration, and immersive training.

Real estate: Virtual staging technologies, particularly those leveraging LIDAR and AI-based image processing, offer transformative capabilities for the real estate industry. These technologies enable detailed interactive virtual tours and immersive experiences of properties. Utilizing AI-based image processing, such as semantic style transfer and super-resolution, real estate agents can create photorealistic and visually appealing representations of properties. This allows buyers to visualize different interior design options and spatial arrangements, enhancing their decision-making process. The ability to remove clutter and present clean, staged environments also makes properties more attractive and marketable. Furthermore, using LIDAR scanning, accurate 3D models of properties can be created, allowing potential buyers to explore homes remotely as if they were physically present. This not only enhances the buying experience but also broadens the market reach, as international buyers can tour properties without the need for travel. AI-based style transfer can further enhance these tours by enabling dynamic visualization of different interior styles and layouts, helping buyers to envision the potential of each property.

Furniture retail: In the furniture retail sector, virtual staging technologies can revolutionize the way products are showcased and sold. These technologies enable customers to visualize how different pieces of furniture will look in their homes before making a purchase, eliminating the need to visit the furniture showroom. Using AI-based systems for rendering and super-resolution, retailers can create high-quality, interactive 3D models of furniture within various room settings. This not only improves the shopping experience by allowing customers to explore different styles and arrangements but also reduces return rates by providing a clearer expectation of how products will fit and look in their intended spaces. Moreover, by integrating AI based image processing pipelines, retailers can create virtual showrooms where customers can visualize furniture in various settings and configurations. This interactive experience can help customers make more informed purchasing decisions by seeing how different pieces fit together and complement existing decor. Super-resolution models and semantic style transfer can enhance the realism of these virtual showrooms, making the virtual furniture appear as realistic as possible.

Interior design: Interior designers benefit from virtual staging technologies by being able to present clients with a range of design options without the need for physical samples. AI models for multitask dense prediction allow designers to experiment with different colors, materials, and layouts in a virtual environment. This speeds up the design process and enhances client satisfaction by providing a clear and realistic preview of the final outcome. The ability to generate stereoscopic environments facilitates a more immersive and engaging client presentation. AI-based image processing can generate high-fidelity, photorealistic visualizations of design proposals, allowing clients to see precisely how their spaces will look after redesign. The ability to quickly switch between different styles and layouts using virtual staging tools can facilitate better client communication and faster decision-making. Additionally, these technologies allow designers to experiment with various elements without the need for physical materials, saving time and resources.

Construction industry: The construction industry can leverage virtual staging technologies to improve project visualization and collaboration. LIDAR-based pipelines provide accurate 3D models of construction sites, which can be used for planning and monitoring progress. AI-based tools for depth estimation and view synthesis help create detailed virtual environments that reflect the current state of a project. These technologies enable stakeholders to conduct virtual walkthroughs, identify potential issues early, and make informed decisions, thus enhancing efficiency and reducing costs. Moreover, these technologies can be used to visualize building projects before completion, ensuring they are constructed as designed. Building owners can leverage these technologies to showcase how unfinished buildings will appear once completed, enabling them to market and sell properties before construction is finalized. This capability also improves project coordination and stakeholder communication, ultimately leading to more efficient project execution.

Remote collaboration: The integration of virtual staging technologies into remote collaboration platforms can significantly enhance the way teams work together. High-resolution, interactive virtual environments can facilitate better communication and collaboration among team members who are geographically dispersed. For example, architects and engineers can collaboratively review and edit virtual models of their projects in real-time, making adjustments and discussing changes as if they were in the same room, leading to more cohesive teamwork and faster project timelines.

Immersive training: In the context of immersive training, virtual staging technologies offer a safe and controlled environment for training simulations. AI-driven models for semantic segmentation, depth estimation, and interactive rendering create realistic scenarios that can be used for training purposes in fields such as healthcare, emergency response, and military operations. The ability to create detailed and interactive virtual environments ensures that trainees can practice and hone their skills in a lifelike setting, improving the overall effectiveness of the training programs.

The disclosed technology proposes a comprehensive exploration of virtual staging technologies within the context of the metaverse, focusing on two primary pipelines: an AI based image processing pipeline, and a LIDAR-based pipeline. The qualitative comparison highlighted the strengths and limitations of each approach, demonstrating their potential to revolutionize various industries, including real estate, interior design, and immersive training. The LIDAR-based pipeline excels in generating highly accurate 3D models of indoor environments, making it ideal for applications requiring detailed spatial data and full physics integration. Its ability to provide real-time, interactive editing and collaboration in virtual spaces showcases its suitability for immersive design and construction monitoring. However, the need for specialized equipment and the challenges associated with processing complex environments limit its broader application. On the other hand, the AI-based image processing pipeline offers significant advantages in terms of flexibility, efficiency, and ease of use. By leveraging advanced AI algorithms for tasks such as clutter removal, semantic style transfer, and super resolution, this pipeline can rapidly generate high-quality, photorealistic virtual environments from single panoramic images. Its applicability in virtual staging, where photo-realism and rapid deployment are critical, underscores its potential for transforming the real estate and furniture retail sectors.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An AI-based image processing system for immersive editing and collaborative design, the system comprising:
an input image,
an instant clutter removal module,
a multitask dense prediction module,
an indoor style transfer module,
a hybrid attention mechanism, wherein the hybrid attention mechanism is an extension resolution of an indoor spherical representations module,
an editing module, and
an automatic stereo generation module.

2. The system of claim 1, wherein the input image is a spherical shot of a panoramic indoor scene.

3. The system of claim 1, wherein the hybrid attention module comprises channel attention, window-attention, and overlapping cross-attention to activate input pixels for SR.

4. The system of claim 1, wherein the instant clutter removal module comprises a model based on inpainting for Instant Automatic Emptying of Panoramic Indoor Scenes.

5. The system of claim 4, wherein the instant clutter removal module automatically removes clutter from panoramic indoor images.

6. The system of claim 1, wherein the multitask dense prediction module comprises a deep-learning framework configured to infer multiple pixel-wise signals from a single panoramic image.

7. The system of claim 6, wherein the multitask dense prediction module is configured to concurrently extract information from the input image.

8. The system of claim 7, wherein the information is at least one of depth, normals, semantic segmentation, reflectance, or shading from the input image.

9. The system of claim 7, wherein the information is extracted through a transformer-based encoder-decoder architecture that leverages a plurality of heads for dense estimation.

10. The system of claim 1, wherein the indoor style transfer module is configured to change an appearance of indoor environments to look like a target scene.

11. The system of claim 1, wherein the indoor style transfer module integrates a plurality of components into a generative deep model.

12. The system of claim 11, wherein the plurality of components comprises a shading decomposition scheme to separate reflectance (albedo) from shading, geometry constraints using layout and depth inference during training and enforcing shape consistency between generated and ground truth scenes, and a hybrid-attention-based super-resolution technique to enhance detail and resolution of generated images.

13. The system of claim 1, wherein the extension resolution of indoor spherical representations module generates super-resolution outputs for both RGB and depth signals using a super-resolution model based on a Hybrid Attention Mechanism.

14. The system of claim 1, wherein the editing module comprises a series of advanced deep-learning models to configured to process, edit, and render spherical images of indoor environments.

15. The system of claim 1, wherein the automatic stereo generation module is configured to automatically generate stereoscopic environments for metaverse applications.

16. The system of claim 15, wherein the automatic stereo generation module is configured for deep synthesis and exploration of omnidirectional stereoscopic environments from a single surround-view.

17. A method of using an AI-based image processing system for immersive editing and collaborative design, the method comprising:
receiving an input image,
putting the input image through an instant clutter removal module,
putting the input image through a multitask dense prediction module,
putting the input image through an indoor style transfer module,
putting the input image through a hybrid attention mechanism, wherein the hybrid attention mechanism is an extension resolution of an indoor spherical representations module,
putting the input image through an editing module, and
putting the input image through an automatic stereo generation module.

18. The method of claim 17, wherein the input image is a spherical shot of a panoramic indoor scene.

19. The method of claim 17, wherein the hybrid attention module comprises channel attention, window-attention, and overlapping cross-attention to activate input pixels for SR, wherein the instant clutter removal module comprises a model based on inpainting for Instant Automatic Emptying of Panoramic Indoor Scenes, wherein the multitask dense prediction module comprises a deep-learning framework configured to infer multiple pixel-wise signals from a single panoramic image, wherein the indoor style transfer module is configured to change an appearance of indoor environments to look like a target scene, wherein the indoor style transfer module integrates a plurality of components into a generative deep model, wherein the extension resolution of indoor spherical representations module generates super-resolution outputs for both RGB and depth signals using a super-resolution model based on a Hybrid Attention Mechanism, wherein the editing module comprises a series of advanced deep-learning models to configured to process, edit, and render spherical images of indoor environments, and wherein the automatic stereo generation module is configured to automatically generate stereoscopic environments for metaverse applications.

20. The method of claim 19, wherein the instant clutter removal module automatically removes clutter from panoramic indoor images, wherein the multitask dense prediction module is configured to concurrently extract information from the input image, wherein the information is at least one of depth, normals, semantic segmentation, reflectance, or shading from the input image, wherein the information is extracted through a transformer-based encoder-decoder architecture that leverages a plurality of heads for dense estimation, wherein the plurality of components comprises a shading decomposition scheme to separate reflectance (albedo) from shading, geometry constraints using layout and depth inference during training and enforcing shape consistency between generated and ground truth scenes, and a hybrid-attention-based super-resolution technique to enhance detail and resolution of generated images, and wherein the automatic stereo generation module is configured for deep synthesis and exploration of omnidirectional stereoscopic environments from a single surround-view.
